(19) United States
(12) Patent Application Publication
(10) Pub. No.: US 2026/0224016 A1
(43) Pub. Date: Aug. 6, 2026

(54) Integrated Vehicle Shoe Brush Device

(71) Applicant: Gaetano Catanzaro, Plantation, FL (US)

(72) Inventor: Gaetano Catanzaro, Plantation, FL (US)

(21) Appl. No.: 19/175,082

(22) Filed: Apr. 10, 2025

Related U.S. Application Data
(60) Provisional application No. 63/752,108, filed on Jan. 31, 2025.

(51) Int. Cl. A46B 5/00; A46B 15/00; A47L 23/00; B60R 99/00

(52) U.S. Cl. CPC A46B 5/0033; A46B 15/0004; A47L 23/00; B60R 99/00; A46B 2200/306

(57) ABSTRACT

An integrated vehicle shoe brush device is provided. The device is comprised of a vehicle integrated shoe brush device designed to remove dirt, mud, and debris from shoe soles before entering a vehicle. The device comprises a brush member and a deployment and retraction mechanism that extends and retracts the brush from various positions, including a vehicle door, a door jamb, or the vehicle's bottom surface. Different embodiments incorporate hinged arm systems, sliding track mechanisms, spring-loaded mechanisms, or motorized mechanisms to enable manual or automatic operation. In manual configurations, passive retraction and foot-push activation facilitate use without electrical power, while motorized systems enable hands-free operation by integrating with the vehicle's electrical system.

### CROSS-REFERENCE TO RELATED APPLICATION

The present application claims priority to, and the benefit of, U.S. Provisional Application No. 63/752,108, which was filed on January 31, 2025, and is incorporated herein by reference in its entirety.

### FIELD OF THE INVENTION

The present invention relates generally to the field of shoe-cleaning devices. More specifically, the present invention relates to a deployable vehicle integrated shoe brush device designed to remove dirt, mud, and debris from shoe soles before entering a vehicle. Accordingly, the present disclosure makes specific reference thereto. Nonetheless, it is to be appreciated that aspects of the present invention are also equally applicable to other like applications, devices, and methods of manufacture.

### BACKGROUND

When individuals enter a vehicle, dirt, mud, and debris accumulated on the soles of their shoes can be transferred to the vehicle’s interior. This issue is particularly problematic in environments where footwear frequently collects outdoor materials such as leaves, dust, or snow. Over time, the accumulation of these materials can result in unsanitary conditions, requiring frequent cleaning and maintenance. Traditional solutions, such as floor mats, can capture some debris but do not prevent dirt from entering in the first place. Additionally, individuals may attempt to wipe their shoes on the ground or use their hands to remove debris before entering a vehicle, which is often inconvenient and ineffective. While some vehicles have built-in step areas or textured surfaces near entry points, these do not actively assist in cleaning footwear. The lack of an integrated, efficient method to remove shoe debris before entering a vehicle contributes to a persistent issue that affects vehicle cleanliness and hygiene. As a result, there is a need for a dedicated device that allows users to clean their shoes efficiently before stepping inside a vehicle.

Therefore, there exists a long-felt need in the art for an integrated vehicle shoe brush device that enables users to remove dirt, mud, and debris from their shoe soles before entering a vehicle. There also exists a long-felt need in the art for an integrated vehicle shoe brush device that automatically or manually deploys and retracts in coordination with the vehicle door, ensuring accessibility and ease of use. Moreover, there exists a long-felt need in the art for an integrated vehicle shoe brush device that is adaptable to different vehicle types and configurations without compromising the structural integrity or functionality of the vehicle.

The subject matter disclosed and claimed herein, in one embodiment thereof, comprises an integrated vehicle shoe brush device. The device is comprised of a vehicle integrated shoe brush device designed to remove dirt, mud, and debris from shoe soles before entering a vehicle. The device comprises a brush member and a deployment and retraction mechanism that extends and retracts the brush from various positions, including a vehicle door, a door jamb, or the vehicle's bottom surface. Different embodiments incorporate hinged arm systems, sliding track mechanisms, spring-loaded mechanisms, or motorized mechanisms to enable manual or automatic operation. In manual configurations, passive retraction and foot-push activation facilitate use without electrical power, while motorized systems enable hands-free operation by integrating with the vehicle's electrical system. A method of using the device involves the brush deploying upon door opening, engaging with the user's shoe sole for cleaning, and retracting when the door closes, ensuring minimal interior contamination and enhanced convenience across various vehicle types.

In this manner, the integrated vehicle shoe brush device of the present invention accomplishes all the foregoing objectives and provides a built-in device that effectively removes debris from shoe soles before individuals enter a vehicle. Various configurations, including placement within the vehicle door, door jamb, or bottom surface, allow for adaptability across different vehicle designs. In addition, both manual and automatic operation options provide convenience for users, with spring-loaded and motorized mechanisms enabling hands-free functionality. By integrating a dedicated cleaning device into the vehicle structure, the invention enhances vehicle cleanliness, reduces the need for frequent interior maintenance, and improves overall user experience.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an integrated vehicle shoe brush device. The integrated vehicle shoe brush device facilitates the removal of dirt, mud, and debris from shoes before entering a vehicle. The device is comprised of a deployment and retraction mechanism that extends a brush member from a portion of a vehicle, providing a cleaning surface for shoe soles.

In one embodiment, the device is positioned within a vehicle door. The brush member extends when the door opens and retracts when the door closes, deploying either downward or horizontally. In another embodiment, the device is positioned on the side of a vehicle door jamb. The brush member extends outward when the door opens and retracts when the door closes, moving horizontally, vertically, or in a combination of both. In a further embodiment, the device is positioned on a bottom surface of the vehicle near a step area. In this configuration, the brush member moves downward upon door opening and retracts upward when the door closes, allowing for shoe cleaning without interfering with door functionality.

The brush member is designed for effective debris removal, comprising bristles made from durable materials such as synthetic fibers, rubber, or metal wire. The bristles are rigid enough to dislodge debris while remaining flexible to conform to shoe soles. In some embodiments, the brush member is positioned at an angle to ensure full contact with the shoe sole during use, enhancing cleaning efficiency.

The device can be manually or automatically operated. In the manual configuration, a spring-loaded mechanism allows for passive retraction, and a foot-push activation mechanism enables deployment without an electrical system. In the automatic configuration, a motorized mechanism powered by the vehicle’s electrical system synchronizes brush deployment and retraction with door movement, ensuring hands-free operation.

The invention also includes a method of use. Upon opening the vehicle door, the brush member extends from the door, door jamb, or bottom surface of the vehicle. The user engages the brush by placing a shoe sole against the bristles and moving it back and forth to remove debris before stepping into the vehicle. When the door closes, the brush member retracts to its stowed position.

Accordingly, the integrated vehicle shoe brush device of the present invention is particularly advantageous as it provides a built-in device that effectively removes debris from shoe soles before individuals enter a vehicle. Various configurations, including placement within the vehicle door, door jamb, or bottom surface, allow for adaptability across different vehicle designs. In addition, both manual and automatic operation options provide convenience for users, with spring-loaded and motorized mechanisms enabling hands-free functionality. By integrating a dedicated cleaning device into the vehicle structure, the invention enhances vehicle cleanliness, reduces the need for frequent interior maintenance, and improves overall user experience.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of multiple potential embodiments of an integrated vehicle shoe brush device of the present invention while attached to a vehicle in accordance with the disclosed architecture;

FIG. 2 illustrates a flowchart of a method of using one potential embodiment of an integrated vehicle shoe brush device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an integrated vehicle shoe brush device that enables users to remove dirt, mud, and debris from their shoe soles before entering a vehicle. There also exists a long-felt need in the art for an integrated vehicle shoe brush device that automatically or manually deploys and retracts in coordination with the vehicle door, ensuring accessibility and ease of use. Moreover, there exists a long-felt need in the art for an integrated vehicle shoe brush device that is adaptable to different vehicle types and configurations without compromising the structural integrity or functionality of the vehicle.

The present invention, in one exemplary embodiment, is comprised of an integrated vehicle shoe brush device. The integrated vehicle shoe brush device aids in the removal of dirt, mud, and debris from shoes before entering a vehicle. The device is comprised of a deployment and retraction mechanism that extends a brush member from a portion of the vehicle, providing a cleaning surface for shoe soles.

In one embodiment, the device is positioned within a vehicle door, where the brush member extends when the door opens and retracts when the door closes, deploying either downward or horizontally. In another embodiment, the device is located on the side of a vehicle door jamb, with the brush member extending outward when the door opens and retracting when the door closes, moving horizontally, vertically, or in a combination of both. In a further embodiment, the device is mounted on the bottom surface of the vehicle near a step area. In this configuration, the brush member moves downward upon door opening and retracts upward when the door closes, allowing for shoe cleaning without interfering with door functionality.

The brush member is designed for effective debris removal, comprising bristles made from durable materials such as synthetic fibers, rubber, or metal wire. The bristles are rigid enough to dislodge debris while remaining flexible to conform to shoe soles. In certain embodiments, the brush member is positioned at an angle to ensure full contact with the shoe sole during use, enhancing cleaning efficiency.

The device may operate manually or automatically. In the manual configuration, a spring-loaded mechanism enables passive retraction, while a foot-push activation mechanism allows deployment without requiring an electrical system. In the automatic configuration, a motorized mechanism powered by the vehicle’s electrical system synchronizes brush deployment and retraction with door movement, enabling hands-free operation.

The invention also includes a method of use. When the vehicle door opens, the brush member extends from the door, door jamb, or bottom surface of the vehicle. The user engages the brush by placing a shoe sole against the bristles and moving it back and forth to remove debris before stepping into the vehicle. When the door closes, the brush member retracts to its stowed position.

As a result, the integrated vehicle shoe brush device provides a built-in solution for effectively removing debris from shoe soles before entering a vehicle. Various configurations, including placement within the vehicle door, door jamb, or bottom surface, allow adaptability across different vehicle designs. Additionally, both manual and automatic operation options offer user convenience, with spring-loaded and motorized mechanisms enabling hands-free functionality. By integrating a dedicated cleaning device into the vehicle structure, the invention enhances vehicle cleanliness, reduces the need for frequent interior maintenance, and improves overall user experience.

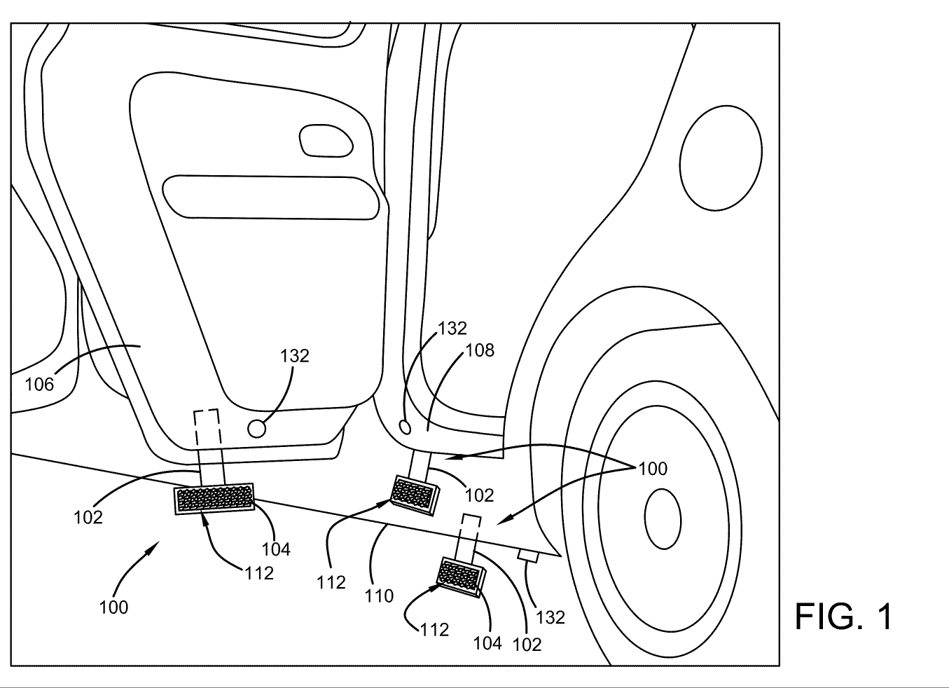

Referring initially to the drawings, FIG. 1 illustrates a perspective view of multiple potential embodiments of an integrated vehicle shoe brush device 100 of the present invention while attached to a vehicle in accordance with the disclosed architecture. The integrated vehicle shoe brush device 100 is designed to facilitate the removal of dirt, mud, and debris from shoes before entering a vehicle. The device 100 is comprised of a deployment and retraction mechanism 102 that allows a brush member 104 to extend from a portion of a vehicle, effectively providing a cleaning surface for shoe soles.

In one embodiment (as seen in FIG. 1), the device 100 is positioned within a vehicle door 106. In this configuration, the brush member 104 extends from the door 106 when the door 106 opens and retracts into the door 106 as the door 106 closes. The brush member 104 may extend downward (toward a ground surface) or horizontally (in a direction parallel to a bottom edge of the door 106), depending on the specific implementation. The deployment and retraction mechanism 102 in this embodiment may include or may be any combination of a hinged arm system, a sliding track mechanism, a spring-loaded mechanism, or a motorized mechanism. The hinged arm embodiment preferably swings the brush member 104 outward when the door 106 opens and retracts it when the door 106 closes. If mounted at the bottom edge of the door 106, the hinged arm system allows the brush member 104 to move downward into position upon deployment. The sliding track mechanism enables the brush member 104 to extend and retract along a guided path. In manual configurations, the spring-loaded mechanism provides passive retraction, automatically returning the brush member 104 to its stowed position when not in use. In an automatic configuration, a motorized mechanism is powered by the vehicle’s electrical system, allowing the brush member 104 to deploy and retract in coordination with the movement of the door 106, providing hands-free operation.

In another embodiment (as seen in FIG. 1), the device 100 is positioned on the side of a vehicle door jamb 108. In this embodiment, the deployment and retraction mechanism 102 extends the brush member 104 outward when the door 106 opens and retracts it when the door 106 closes. The brush member 104 may extend either horizontally (perpendicular to the door jamb 108), vertically, or some combination thereof. The deployment and retraction mechanism 102 in this embodiment may include or may be any combination of a hinged arm system, a sliding track mechanism, a spring-loaded mechanism, or a motorized mechanism. The hinged arm embodiment swings the brush member 104 outward from the door jamb 108 when the door 106 opens and retracts it when the door 106 closes. The sliding track mechanism allows the brush member 104 to extend outward and retract along a guided path. In manual configurations, the spring-loaded mechanism provides passive retraction, automatically restoring the brush member 104 to its stowed position when not in use. In an automatic configuration, a motorized mechanism is powered by the vehicle’s electrical system, synchronizing the deployment and retraction of the brush member 104 with the movement of the door 106, ensuring hands-free operation.

In a further embodiment (as seen in FIG. 1), the device 100 is positioned on the bottom surface 110 of the vehicle near a step area. In this configuration, the deployment and retraction mechanism 102 moves the brush member 104 downward (towards a ground surface) upon door 106 opening and retracts it upward when the door 106 closes. This placement allows for effective shoe cleaning without affecting the functionality of the door 106 itself. The deployment and retraction mechanism 102 in this embodiment may include or may be any combination of a hinged arm system, a sliding track mechanism, a spring-loaded mechanism, or a motorized mechanism. The hinged arm system allows the brush member 104 to pivot downward from the bottom surface 110 when deployed and return to a retracted position when the door 106 closes. The sliding track mechanism enables the brush member 104 to extend and retract along a guided path beneath the vehicle. The spring-loaded mechanism provides passive retraction, allowing the brush member 104 to return to its stowed position without requiring external power. In the automatic configuration, a motorized mechanism is powered by the vehicle’s electrical system, facilitating seamless deployment and retraction of the brush member 104 in response to the opening and closing of the door 106.

The brush member 104 is specifically designed to maximize effectiveness in removing dirt, mud, and debris from shoe soles. The brush member 104 is comprised of a plurality of bristles 112, which may be made from durable materials such as synthetic fibers, rubber, or metal wire to ensure longevity and resistance to wear. The bristles 112 are sufficiently rigid to dislodge debris while remaining flexible enough to conform to the contours of a shoe sole. In one embodiment, the brush member 104 is positioned at an angle relative to the ground surface when deployed to ensure full contact with a shoe sole during use. This angled positioning enhances the efficiency of the cleaning process while reducing the need for repeated passes over the bristles 112. The density and arrangement/pattern of the bristles 112 may vary in different embodiments to accommodate different types of footwear and levels of dirt accumulation.

As noted, the device 100 can be configured for either manual or automatic operation. In the manual configuration, a spring-loaded mechanism provides passive retraction, allowing the brush member 104 to return to its stowed position without requiring external power. Additionally, a foot-push activation mechanism 132 may be incorporated, enabling users to engage the brush member 104 by stepping on, touching, or pressing a designated actuator, which deploys the mechanism 102 to deploy and/or retract the brush member 104 without the need for an electrical system. The mechanism 132 may be located anywhere on a vehicle in different embodiments and may be in the form of a button, etc. In the automatic configuration, a motorized mechanism powered by the vehicle’s electrical system controls the extension and retraction of the brush member 104 in synchronization with the opening and closing of the vehicle door 106. This hands-free operation enhances user convenience and ensures consistent performance.

As a result, the device 100 provides an effective and practical solution for maintaining cleaner vehicle interiors by reducing the amount of dirt and debris tracked inside. The various embodiments and configurations allow for adaptability across different vehicle types, ensuring that users can benefit from the shoe-cleaning functionality without compromising the design or operation of the vehicle.

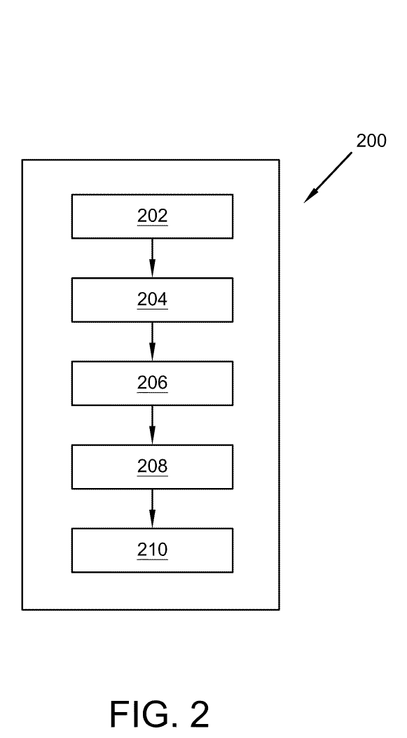

The present invention is also comprised of a method of using 200 the device 100, as seen in FIG. 2. First, the device 100 is provided, wherein the device 100 is positioned in at least one of a vehicle door 106, a vehicle door jamb 108, or a bottom surface 110 of the vehicle, and wherein the device 100 is comprised of a brush member 104 and a deployment and retraction mechanism 102 [Step 202]. Then, upon opening the vehicle door 106, the deployment and retraction mechanism 102 extends the brush member 104 outward from the vehicle door 106, the vehicle door jamb 108, or downward from the bottom surface 110 of the vehicle [Step 204]. If positioned in the vehicle door 106, the brush member 104 extends either downward or horizontally. If positioned in the door jamb 108, the brush member 104 extends outward in a horizontal and/or vertical direction. If positioned on the bottom surface 110 of the vehicle, the brush member 104 extends downward toward a ground surface. Next, a user engages the brush member 104 by placing a shoe sole in contact with the bristles 112 and moving the shoe back and forth, thereby removing dirt, mud, and debris from the shoe sole [Step 206]. Then, the user can step into the vehicle [Step 208]. Finally, upon closing the vehicle door 106, the deployment and retraction mechanism 102 retracts the brush member 104 into the vehicle door 106, the door jamb 108, or the bottom surface 110 of the vehicle, returning the brush member 104 to a stowed position [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “integrated vehicle shoe brush device” and “device” are interchangeable and refer to the integrated vehicle shoe brush device 100 of the present invention.

Notwithstanding the foregoing, the integrated vehicle shoe brush device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the integrated vehicle shoe brush device 100 as shown in the FIGS. are for illustrative purposes only, and that many other sizes and shapes of the integrated vehicle shoe brush device 100 are well within the scope of the present disclosure. Although the dimensions of the integrated vehicle shoe brush device 100 are important design parameters for user convenience, the integrated vehicle shoe brush device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An integrated vehicle shoe brush device comprising:
a brush member comprised of a plurality of bristles, the brush member positioned in a vehicle door jamb; and
a deployment and retraction mechanism coupled to the brush member, the deployment and retraction mechanism configured to extend the brush member outward from the vehicle door jamb when a vehicle door opens and retract the brush member toward the vehicle door jamb when the vehicle door closes.

2. The integrated vehicle shoe brush device of claim 1, wherein the deployment and retraction mechanism comprises a hinged arm system, a sliding track mechanism, a spring-loaded mechanism, or a motorized mechanism.

3. The integrated vehicle shoe brush device of claim 2, wherein the motorized mechanism synchronizes the deployment and the retraction of the brush member with a movement of the vehicle door.

4. The integrated vehicle shoe brush device of claim 1, wherein the plurality of bristles are comprised of a synthetic fiber, a rubber, or a metal wire.

5. The integrated vehicle shoe brush device of claim 1 further comprised of a foot-push activation mechanism.

6. The integrated vehicle shoe brush device of claim 5, wherein pressing the foot-push activation mechanism deploys the brush member via the deployment and retraction mechanism.

7. An integrated vehicle shoe brush device comprising:
a brush member comprised of a plurality of bristles, the brush member positioned in a vehicle door; and
a deployment and retraction mechanism coupled to the brush member, the deployment and retraction mechanism configured to extend the brush member from the vehicle door when the vehicle door opens and retract the brush member into the vehicle door when the vehicle door closes.

8. The integrated vehicle shoe brush device of claim 7, wherein the deployment and retraction mechanism comprises a hinged arm system, a sliding track mechanism, a spring-loaded mechanism, or a motorized mechanism.

9. The integrated vehicle shoe brush device of claim 8, wherein the motorized mechanism synchronizes the deployment and the retraction of the brush member with a movement of the vehicle door.

10. The integrated vehicle shoe brush device of claim 7, wherein the plurality of bristles are comprised of a synthetic fiber, a rubber, or a metal wire.

11. The integrated vehicle shoe brush device of claim 7 further comprised of a foot-push activation mechanism.

12. The integrated vehicle shoe brush device of claim 11, wherein pressing the foot-push activation mechanism deploys the brush member via the deployment and retraction mechanism.

13. The integrated vehicle shoe brush device of claim 11, wherein the foot-push activation mechanism is comprised of a sensor.

14. An integrated vehicle shoe brush device comprising:
a brush member comprised of a plurality of bristles, the brush member positioned on a bottom surface of a vehicle; and
a deployment and retraction mechanism coupled to the brush member, the deployment and retraction mechanism configured to extend the brush member downward from the bottom surface of the vehicle upon opening of a vehicle door and retract the brush member upward toward the bottom surface of the vehicle upon closing of the vehicle door.

15. The integrated vehicle shoe brush device of claim 14, wherein the deployment and retraction mechanism comprises a hinged arm system, a sliding track mechanism, a spring-loaded mechanism, or a motorized mechanism.

16. The integrated vehicle shoe brush device of claim 15, wherein the motorized mechanism synchronizes the deployment and the retraction of the brush member with a movement of the vehicle door.

17. The integrated vehicle shoe brush device of claim 14, wherein the plurality of bristles are comprised of a synthetic fiber, a rubber, or a metal wire.

18. The integrated vehicle shoe brush device of claim 14 further comprised of a foot-push activation mechanism.

19. The integrated vehicle shoe brush device of claim 18, wherein pressing the foot-push activation mechanism deploys the brush member via the deployment and retraction mechanism.

20. The integrated vehicle shoe brush device of claim 18, wherein the foot-push activation mechanism is comprised of a sensor.
